(19) United States
(12) Patent Application Publication
(10) Pub. No.: US 2006/0004950 A1
(43) Pub. Date: Jan. 5, 2006

(54) Flash memory file system having reduced headers

(76) Inventors: Jeffrey Wang, Shanghai (CN); John C. Rudelic, Folsom, CA (US); Sujaya Srinivasan, Folsom, CA (US); Sunil R. Atri, Folsom, CA (US)

Correspondence Address: LeMoine Patent Services, PLLC;c/o PortfolioIP, P.O. Box 52050, Minneapolis, MN, 55402, US

(21) Appl. No.: 10/880,993

(22) Filed: Jun. 30, 2004

(51) Int. Cl. G06F 12/00

(52) U.S. Cl. 711/103; 711/159

(57) ABSTRACT

A flash memory file system includes fragments and headers. The headers have a reduced number of states.

### FIELD

The present invention relates generally to file systems, and more specifically to file systems in flash memory devices.

### BACKGROUND

Flash memories may have file systems to hold files. Because flash memories are nonvolatile, files in a flash memory should be available after power to the flash memory is cycled. If power is lost when a file in a flash memory is being modified, the file may be corrupt when power is restored.

### BRIEF DESCRIPTION OF THE DRAWINGS

FIG. 1 shows a diagram of a processor and a memory device in accordance with various embodiments of the present invention;

FIG. 2 shows portions of a file system in a non-volatile memory;

FIG. 3 shows data structures in a sequence table entry;

FIG. 4 shows a header data structure;

FIG. 5 shows a state diagram for a header;

FIGS. 6 and 7 show flowcharts in accordance with various embodiments of the present invention; and

FIG. 8 shows an electronic system in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

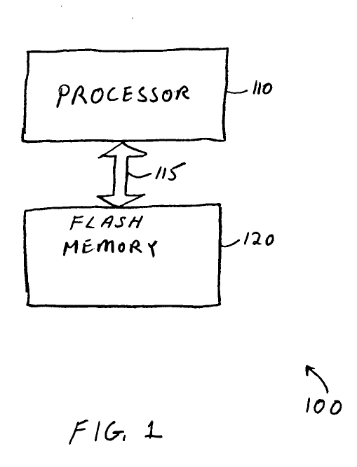

FIG. 1 shows a diagram of a processor and a memory device in accordance with various embodiments of the present invention. As shown in FIG. 1, electronic system 100 includes processor 110 and flash memory device 120. Processor 110 may be any type of processor adapted to perform operations in flash memory device 120. For example, processor 110 may be a microprocessor, a digital signal processor, a microcontroller, or the like.

Flash memory 120 is a nonvolatile memory device. For example, flash memory device 120 may be a memory device with memory cells having floating gate transistors. By storing varying amounts of charge on the floating gates of the transistors and thereby changing the threshold voltage, information may be stored in the memory cells. In some embodiments, a single bit of information may be stored in each cell, and in other embodiments, multiple bits of information may be stored in each cell. For example, in some embodiments, flash memory device 120 is a multi-level cell (MLC) flash memory device with the ability to store multiple different amounts of charge on floating gates, resulting in more than two storage states for each cell.

Processor 110 and flash memory device 120 are coupled by bus 115. In some embodiments of the present invention, processor 110 and flash memory device 120 are included on an integrated circuit board, and bus 115 is implemented using traces on the circuit board. In other embodiments, processor 110 and flash memory device 120 are included within the same integrated circuit, and bus 115 is implemented using interconnect within the integrated circuit.

Processor 110 may perform operations in flash memory device 120. For example, in some embodiments, processor 110 may maintain a file system in flash memory device 120. The file system may hold files along with information describing the files. In some embodiments, system 100 is a flash memory device, and processor 110 is a controller that, as part of the memory device, maintains a file system. In other embodiments, processor 110 is not dedicated to the use of flash memory device 120, and processor 110 maintains a file system in flash memory 120 while also performing other system functions.

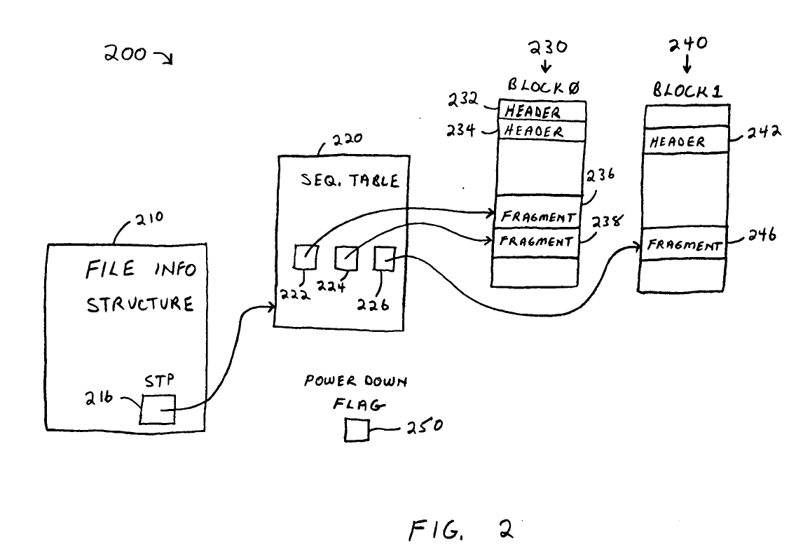

FIG. 2 shows portions of a file system in a non-volatile memory. In some embodiments, file system 200 is maintained in a non-volatile memory such as flash memory device 120 (FIG. 1). File system 200 includes a file information structure 210, sequence table 220, blocks 230 and 240, and power-down flag 250. As shown in FIG. 2, file information structure 210 includes a sequence table pointer (STP) 216. File information structure 210 may include more information than is shown in FIG. 2. For example, file information structure 210 may include the filename, creation date, size of the file, or any other information relating to the file in flash memory.

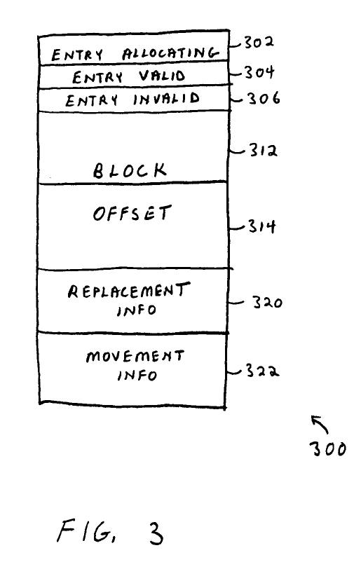

Sequence table pointer 216 includes a pointer to sequence table 220. Sequence table 220 includes sequence table entries 222, 224, and 226. Sequence table entries 222, 224, and 226 point to memory fragments that hold file data. By traversing the entries in sequence table 220, the file in file system 200 may be read. In some embodiments, each of sequence table entries 222, 224, and 226 includes an index to identify a memory block, and an offset into the block to identify the location of the memory fragment holding file data. Sequence table entries are described further below with reference to FIG. 3.

Blocks 230 and 240 represent blocks of memory within a flash memory device. For example, in some embodiments, a flash memory device may be organized into multiple blocks of memory, were each block may be erased separately from the remaining blocks in the flash memory. In other embodiments, a flash memory device may be divided into blocks where each block is a separately addressable portion of a memory area.

In some embodiments, each block is divided into fragments, and each fragment may hold a portion of a file in a file system. For example, as shown in FIG. 2, block 230 includes fragments 236 and 238, and block 240 includes fragment 246. Further, each fragment may have a header associated therewith. For example, fragment 236 is associated with header 232, fragment 238 is associated with header 234, and fragment 246 is associated with header 242.

Block 230 is shown with two memory fragments, and block 240 is shown with one memory fragment, but this is not a limitation of the present invention. A file may include data held in any number of memory fragments, with each of the memory fragments having a header associated therewith. In some embodiments, memory fragments are of a fixed size. Further, in some embodiments, the size of the various memory fragments is uniform across file system 200. A memory fragment size may be chosen based on many possible factors, including the type of data expected to be stored therein, and the frequency with which it is expected to be changed.

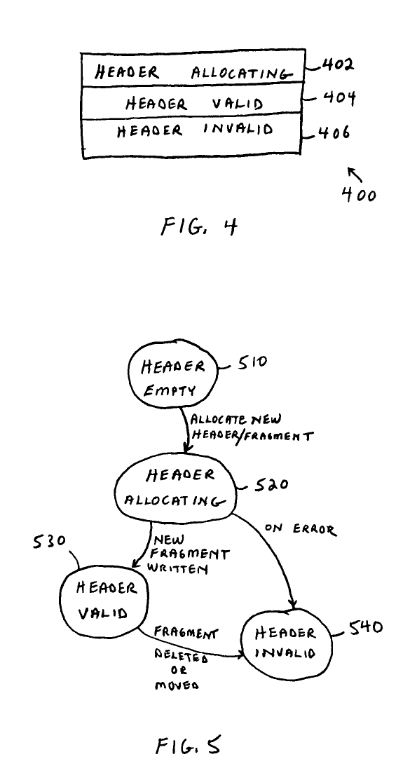

Headers in memory 230 have one or more fields to indicate a status of the associated memory fragment. For example, in some embodiments, each header may be marked to indicate whether a memory fragment is empty, allocating, valid, or invalid. Modifying information in a header represents processing overhead for working with the file system. Benefits may be derived from utilizing headers, but as headers become large and more complex, more processing resources are utilized to maintain the headers, and fewer processing resources are available for working with file data. An example of a header having a reduced size is described below with reference to FIGS. 4 and 5.

File information structure 210 and sequence table 220 are shown as separate blocks in FIG. 2. In some embodiments, file information structure 210 and sequence table 220 are included in a common block of flash memory within a single flash memory device. For example, file information structure 210 and sequence table 220 may be included in a block such as block 240. In these embodiments, an erase operation will erase all of file information structure 210, sequence table 220, and block 240 at the same time. In other embodiments, file information structure 210 and sequence table 220 are distributed across multiple blocks within one or more flash memory devices. In these embodiments, an erase operation may erase a portion of the blocks shown in FIG. 2.

In some embodiments, power-down flag 250 occupies a single cell within the flash memory, and is utilized to indicate whether the flash memory device was last powered-down normally or was subjected to an abnormal power-down sequence. For example, when powering-down normally, a processor may write to power-down flag 250, thereby changing power-down flag 250 from a “1” to a “0.” When power is re-applied to the flash memory, a processor such as processor 110 may read power-down flag 250 to determine whether the flash memory device was last powered down normally. If not, portions of file system 200 may be traversed to determine whether any files need to be repaired. The use of power-down flag 250 is described further below with reference to the remaining figures.

In some embodiments, file system 200 is implemented in a MLC flash memory, and power-down flag 250 occupies a single cell. In these embodiments, the single cell may be programmed to one state to indicate a normal power-down sequence. For example, a multi-state cell may have an erased state of “11” and may be programmed to a state of “00” to indicate a normal power down. By using a multi-level cell in this manner, the multi-level cell is used to store a single bit of information even though two logical bits are written to the cell.

FIG. 3 shows data structures in a sequence table entry. Sequence table entry 300 may be used in a sequence table to point to a file fragment in a flash memory file system. For example, sequence table entry 222, 224, or 226 (FIG. 2) may be implemented as sequence table entry 300. Sequence table entry 300 includes three fields describing the state of the sequence table entry: entry allocating field 302, entry valid field 304, and entry invalid field 306. In some embodiments, these fields each occupy a single bit in a flash memory device, and in some embodiments, each of these fields occupies a single cell of a flash memory device regardless whether the cell is a single bit per cell (SBC) flash memory or a MLC flash memory.

Sequence table entry 300 also includes replacement information 320 and movement information 322. Replacement information 320 and movement information 322 describe whether the sequence table is being, or has been, replaced or moved. For example, if the sequence table has been replaced, replacement information 320 may include a pointer to the location of the replacement sequence table entry. The various embodiments of the present invention are not limited by the contents or format of replacement information 320 and movement information 322.

Sequence table entry 300 also includes block field 312 and offset field 314. Block field 312 includes a pointer to a block or a block index, and offset field 314 includes an offset into the block, and together block field 312 and offset field 314 provide the pointer to a fragment as shown in FIG. 2.

FIG. 4 shows a header data structure. Header data structure 400 may be used as a header in a memory block within a flash memory file system. For example, any of headers 232, 234, or 242 (FIG. 2) may be implemented as header data structure 400. Header data structure 400 includes three fields: header allocating field 402, header valid field 404, and header invalid field 406. These fields are useful for power loss recovery (PLR). A state diagram showing the use of the fields in header data structure 400 is shown in FIG. 5.

In some embodiments, the header fields each occupy a single bit in a flash memory device, and in some embodiments, each of these fields occupies a single cell of a flash memory device regardless of whether the cell is a single bit per cell (SBC) flash memory or a MLC flash memory.

As described above with reference to FIG. 2, maintaining headers in a file system consumes processing resources and results in overhead in terms of system resources and time. For example, writing to the fields in header data structure 400 takes time and other resources that could otherwise be used for working directly with the file data. To reduce overhead, header data structure 400 implements a reduced header for each fragment. The reduced header is implemented by not including any other information describing the fragment beyond state information. For example, header data structure 400 does not include an identifier to identify the file to which it belongs, nor does it include class information describing what component of the file it belongs to, nor does it include attribute information describing which indexing level the fragment is at. This information, and other information, is available elsewhere in the file structure, and may be generated by traversing the memory file by file rather than block by block. Various power loss recovery embodiments described below make use of this information.

FIG. 5 shows a state diagram for a header. State diagram 500 shows states 510, 520, 530, and 540. When a file fragment is erased and has yet to be allocated for use by a file, the associated header will be in “header empty” state 510. Header empty state 510 corresponds to a header with a header data structure (FIG. 4) having no fields programmed. That is, the header allocating field, the header valid field, and the header invalid field have yet to be programmed.

If a memory fragment is to be allocated for use in a file, then the corresponding header changes state to “header allocating” state 520. This corresponds to a header with a header data structure having the header allocating field programmed. This field may be programmed with a single write operation. After the header is marked as allocating, then the file fragment can be written with file data.

After the file fragment is written, the header may change states from header allocating state 520 to “header valid” state 530. This corresponds to a header with a header data structure having the header valid field programmed. This field may be written with a single write operation. If the fragment becomes invalid for any reason, the header changes state from header valid state 530 to “header invalid” state 540. This corresponds to a header with a header data structure having the header invalid field programmed. This field may be written with a single write operation.

The header invalid state 540 may also be entered from header allocating state 520. For example, if an error occurs that prevents the proper writing of the file fragment, the header may bypass the header valid state, and instead directly mark the header as invalid by entering header invalid state 540. In some embodiments, this may occur as a result of a power loss and a subsequent initialization process. If after a power loss, a processor such as processor 110 (FIG. 1) discovers a header in header allocating state 520, the processor may write to the header invalid field and put the header in the header invalid state 540. Pseudo-code for en example initialization process is provided below.

If (normal power down)
{

Build up logical block tables

}
Else
{

Loop (scanning over all directory trees and file data start from root
directory)
{

If (interrupted data)
{

Do recovery for this data
Break loop

}
Else

Continue to the next file

}
Scanning over flash block by block to eliminate the unlinked units
and build up logical block tables

}

As shown in FIG. 5, the entire life of a reduced header such as header data structure 400 may only cause three overhead writes, while still providing enough state information for robust power loss recovery.

FIG. 6 shows a flowchart in accordance with various embodiments of the present invention. In some embodiments, method 600, or portions thereof, is performed by an electronic system, a flash memory file system, or an initialization routine, embodiments of which are described with reference to the various figures. In some embodiments, method 600 or portions thereof is performed in software by a microcontroller within an electronic system or a flash memory device. Method 600 is not limited by the particular type of apparatus or software element performing the method. The various actions in method 600 may be performed in the order presented, or may be performed in a different order. Further, in some embodiments, some actions listed in FIG. 6 are omitted from method 600.

Method 600 begins at 610 in which a field in a flash memory is written to. The field is written to indicate that a normal power down sequence is taking place. In some embodiments, this may correspond to a processor such as processor 110 (FIG. 1) writing to a power-down flag in a flash memory such as power-down flag 250 in file system 200. At 620, the flash memory is powered down. Upon power being re-applied an initialization routine may read the power-down flag to determine whether the last power-down sequence was normal or not.

The power-down flag may occupy a cell in a flash memory regardless of whether the memory is a single bit per cell (SBC) memory or a multi-level cell (MLC) memory. For example, in MLC embodiments, the power-down flag may occupy a single cell by writing a “00” into the cell. By not writing a “01” or “10” into the cell, it may take on either state “11” or “00,” effectively storing a single bit of information in the single MLC cell.

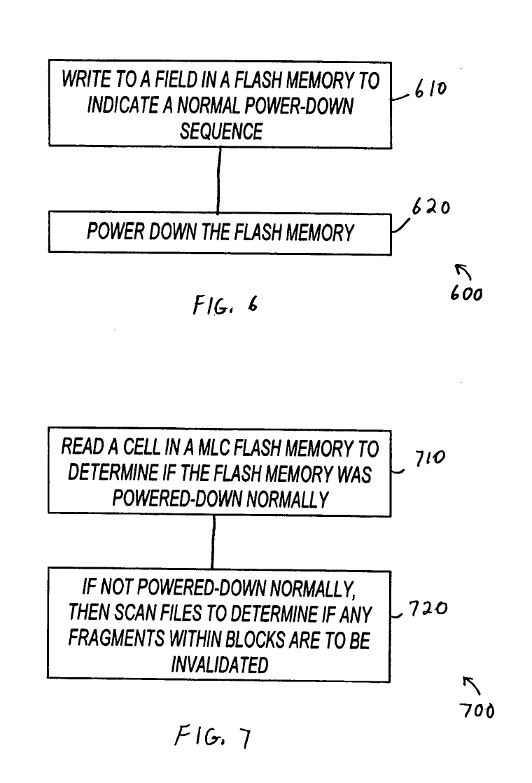

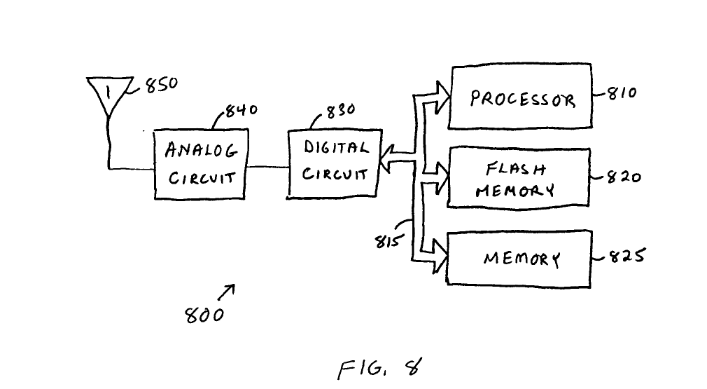

FIG. 7 shows a flowchart in accordance with various embodiments of the present invention. In some embodiments, method 700, or portions thereof, is performed by an electronic system, a flash memory file system, or an initialization routine, embodiments of which are described with reference to the various figures. In some embodiments, method 700 or portions thereof is performed in software by a microcontroller within an electronic system or a memory device. Method 700 is not limited by the particular type of apparatus or software element performing the method. The various actions in method 700 may be performed in the order presented, or may be performed in a different order. Further, in some embodiments, some actions listed in FIG. 7 are omitted from method 700.

Method 700 begins at 710 in which a cell in a MLC flash memory is read to determine if the flash memory was powered down normally. For example, a processor may read a power-down flag in a flash memory file system such as power-down flag 250 (FIG. 2). At 720, if the flash memory was not powered-down normally, the files in the file system are scanned to determine if any fragments within the blocks are to be invalidated. For example, if an abnormal power-down occurred, and a header is in the header allocating state, then an initialization process may write to a header invalid field and cause the header to become invalidated.

In some embodiments, the act of reading a cell to determine if the flash memory was powered-down normally includes checking to see if the cell is erased or programmed. If the cell is erased, then the power-down sequence was performed without the filesystem performing an orderly shutdown. If the cell is programmed, then the filesystem programmed the cell before shutting down to indicate that the normal power-down sequence was followed. An initialization routine may perform the acts of method 700, and if the power down flag is programmed, the initialization routine may erase it. In some embodiments, erasing the power down flag may actually involve relocating the flag to an erased cell in the memory.

FIG. 8 shows a system diagram in accordance with various embodiments of the present invention. Electronic system 800 includes processor 810, flash memory 820, memory 825, digital circuit 830, analog circuit 840, and antenna 850. Processor 810 may be any type of processor adapted to perform operations in flash memory 820. For example, in some embodiments, processor 810 maintains a file system in flash memory 820. For example, processor 810 may be a microprocessor, a digital signal processor, a microcontroller, or the like, that maintains a file system such as file system 200 (FIG. 2) in flash memory 820.

Example systems represented by FIG. 8 include cellular phones, personal digital assistants, wireless local area network interfaces, and the like. Flash memory 820 may be adapted to hold information for system 800. For example, flash memory 820 may hold device configuration data, such as contact information with phone numbers, or settings for digital circuit 830 or analog circuit 840. Many other system uses for flash memory 820 exist. For example, flash memory 820 may be used in a desktop computer, a network bridge or router, or any other system without an antenna.

Analog circuit 840 communicates with antenna 850 and digital circuit 830. In some embodiments, analog circuit 840 includes a physical interface (PHY) corresponding to a communications protocol. For example, analog circuit 840 may include modulators, demodulators, mixers, frequency synthesizers, low noise amplifiers, power amplifiers, and the like. In some embodiments, analog circuit 840 may include a heterodyne receiver, and in other embodiments, analog circuit 840 may include a direct conversion receiver. In some embodiments, analog circuit 840 may include multiple receivers. For example, in embodiments with multiple antennas 850, each antenna may be coupled to a corresponding receiver. In operation, analog circuit 840 receives communications signals from antenna 850, and provides signals to digital circuit 830. Further, digital circuit 830 may provide signals to analog circuit 840, which operates on the signals and then transmits them to antenna 850.

Digital circuit 830 is coupled to communicate with processor 810 and antenna 850. In some embodiments, digital circuit 830 includes circuitry to perform error detection/correction, interleaving, coding/decoding, or the like. Also in some embodiments, digital circuit 830 may implement all or a portion of a media access control (MAC) layer of a communications protocol. In some embodiments, a MAC layer implementation may be distributed between processor 810 and digital circuit 830.

Analog circuit 840 may be adapted to receive and demodulate signals of various formats and at various frequencies. For example, analog circuit 840 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals. The present invention is not limited in this regard.

Antenna 850 may include one or more antennas. For example, antenna 850 may include a single directional antenna or an omni-directional antenna. As used herein, the term omni-directional antenna refers to any antenna having a substantially uniform pattern in at least one plane. For example, in some embodiments, antenna 850 may include a single omni-directional antenna such as a dipole antenna, or a quarter wave antenna. Also for example, in some embodiments, antenna 850 may include a single directional antenna such as a parabolic dish antenna or a Yagi antenna. In still further embodiments, antenna 850 may include multiple physical antennas. For example, in some embodiments, multiple antennas are utilized to support multiple-input-multiple-output (MIMO) processing or spatial-division multiple access (SDMA) processing.

Memory 825 represents an article that includes a machine readable medium. For example, memory 825 represents a random access memory (RAM), dynamic random access memory (DRAM), static random access memory (SRAM), read only memory (ROM), flash memory, or any other type of article that includes a medium readable by processor 810. Memory 825 may store instructions for performing the execution of the various method embodiments of the present invention.

In operation, processor 810 reads instructions and data from memory 825 and performs actions in response thereto. For example, processor 810 may access instructions from memory 825 and perform transacted file operations in a flash file system held in flash memory 820. In some embodiments, flash memory 820 and memory 825 are combined into a single memory device. For example, flash memory 820 and memory 825 may both be include in a single flash memory device.

Although the various elements of system 800 are shown separate in FIG. 8, embodiments exist that combine the circuitry of processor 810, flash memory 820, memory 825 and digital circuit 830 in a single integrated circuit. For example, memory 825 or flash memory 820 may be an internal memory within processor 810 or may be a microprogram control store within processor 810. In some embodiments, the various elements of system 800 may be separately packaged and mounted on a common circuit board. In other embodiments, the various elements are separate integrated circuit dice packaged together, such as in a multi-chip module, and in still further embodiments, various elements are on the same integrated circuit die.

The type of interconnection between processor 810 and flash memory 820 is not a limitation of the present invention. For example, bus 815 may be a serial interface, a test interface, a parallel interface, or any other type of interface capable of transferring command and status information between processor 810, flash memory 820, and memory 825.

In some embodiments, flash memory 820 may be a NOR-type, and in other embodiments, flash memory 820 may be a NAND-type. Memory cells in flash memory 820 may store one data bit per cell, or memory cells may be multilevel cells (MLC) capable of storing more than one bit per cell. Any flash memory arrangement may be utilized within flash memory 820 without departing from the scope of the present invention.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A non-volatile memory containing a data structure with entries to identify locations of file fragments in the non-volatile memory, wherein each of the entries includes a block identifier and an offset into the block.

2. The non-volatile memory of claim 1 wherein the non-volatile memory comprises a flash memory device.

3. The non-volatile memory of claim 1 wherein the non-volatile memory comprises a multi-level cell (MLC) flash memory device.

4. The non-volatile memory of claim 1 further containing a field to indicate whether the non-volatile memory was last powered-down normally.

5. The non-volatile memory of claim 4 wherein the non-volatile memory comprises a multi-level cell (MLC) flash memory device, and the field to indicate whether the non-volatile memory was last powered-down normally occupies one multi-level cell within the flash memory device.

6. The non-volatile memory of claim 5 wherein the one multi-level cell within the flash memory device is written with a “00” to indicate a normal power-down.

7. The non-volatile memory of claim 5 wherein the one multi-level cell within the flash memory device is written with a single bit of information to indicate a normal power-down.

8. The non-volatile memory of claim 1 further comprising a plurality of blocks, wherein each of the plurality of blocks includes a plurality of fragments and one header for each of the plurality of fragments.

9. The non-volatile memory of claim 8 wherein each of the plurality of fragments is a fixed size.

10. A flash memory device having memory arranged in blocks, wherein blocks are arranged to include fragments and headers associated with fragments, and wherein at least one of the headers include a data structure having an allocating field, a valid field, and an invalid field.

11. The flash memory device of claim 10 wherein the fragments are of a uniform size.

12. The flash memory device of claim 10 wherein a block includes a table to include entries identifying fragments that make up a file.

13. The flash memory device of claim 12 wherein the entries include a block identifier and an offset.

14. The flash memory device of claim 10 wherein the flash memory device comprises a multi-level flash memory device.

15. An electronic system comprising:
an antenna,
a processor coupled to the antenna; and
a non-volatile memory having a file system that includes a data structure with entries to identify locations of file fragments in the non-volatile memory, wherein each of the entries includes a logical block identifier and an offset into the logical block.

16. The electronic system of claim 15 wherein the non-volatile memory comprises a flash memory device.

17. The electronic system of claim 15 wherein the non-volatile memory comprises a multi-level flash memory device.

18. The electronic system of claim 15 wherein the file system further includes a field to indicate whether the electronic system was last powered-down normally.

19. A method comprising:
writing to a field in a flash memory to indicate a normal power-down sequence; and
powering down the flash memory.

20. The method of claim 19 wherein writing to the field in flash memory comprises writing to a field in a multi-level cell (MLC) flash memory.

21. The method of claim 20 wherein writing to the field in a MLC flash memory comprises writing to a single MLC cell.

22. The method of claim 21 wherein writing to a single MLC cell comprises writing a “00” pattern to indicate the normal power-down sequence.

23. A method comprising:
reading a cell in a multi-level cell (MLC) flash memory to determine if the flash memory was powered-down normally; and
if the flash memory was not powered-down normally, then scanning files within the flash memory to determine if any fragments within blocks are to be invalidated.

24. The method of claim 23 wherein reading a cell comprises checking whether the cell is erased.

25. The method of claim 24 wherein if the cell is erased, the flash memory was not powered-down normally.

26. The method of claim 23 wherein scanning files comprises scanning files that include fragments and headers associated with the fragments, wherein the headers are marked to indicate a state of a corresponding fragment, wherein the state is selected from the set consisting of: empty, allocating, valid, and invalid.

27. The method of claim 23 further comprising if the cell in the MLC flash memory holds a “00” to indicate the flash memory was powered-down normally, then erasing the cell.
